(19) United States
(12) Patent Application Publication
(10) Pub. No.: US 2025/0314176 A1
(43) Pub. Date: Oct. 9, 2025

(54) Deflector Device and Turbine Guide Shoe

(71) Applicant: PrimeStar (Tianjin) Energy Technology Co., Ltd., Tianjin (CN)

(72) Inventors: Wanwei Cai, Tianjin (CN); Minghao Wang, Tianjin (CN); Donglai Hong, Tianjin (CN)

(21) Appl. No.: 18/628,918

(22) Filed: Apr. 8, 2024

(51) Int. Cl. F01D 9/02; F01D 17/12

(52) U.S. Cl. CPC F01D 9/02; F01D 17/12; F05D 2220/30; F05D 2240/12; F05D 2260/60

(57) ABSTRACT

Disclosed in the present disclosure are a deflector device and a turbine guide shoe. The deflector device includes a deflector body, in which the deflector body is provided with an inlet side and an outlet side opposite to each other, the deflector body is provided with a plurality of deflector channels, the deflector channel is extended in a spiral manner in a direction from the inlet side to the outlet side, and a diameter of the deflector channel is gradually decreased in a direction from the inlet side to the outlet side. The deflector device in the present disclosure is capable of sufficiently increasing the power of the fluid after flowing, which contributes to the full utilization of the energy generated by the fluid.

### FIELD

The present disclosure relates to the technical field of deflector devices and, particularly, to a deflector device and a turbine guide shoe.

### BACKGROUND

Fluid power components are parts that employ fluid as a power source in order to fully utilize the kinetic energy of the fluid. In order to better utilize the energy generated during fluid flow, a number of researchers are investigating different methods, for example, by adjusting the dimensions of the flow channels or by changing the material properties of the components. However, these methods are still not good enough to achieve an increase in fluid power.

### SUMMARY

In order to solve at least one of the existing problems in the prior art mentioned above, in accordance with an aspect of the present disclosure, provided is a deflector device, including a deflector body, in which the deflector body is provided with an inlet side and an outlet side opposite to each other, the deflector body is provided with a plurality of deflector channels, the deflector channel is extended in a spiral manner in a direction from the inlet side to the outlet side, and a diameter of the deflector channel is gradually decreased in a direction from the inlet side to the outlet side.

In some implementations, a cross-section of the deflector channel is elliptical in shape.

In some implementations, any two adjacent deflector channels partially overlap one another at the inlet side.

In some implementations, the deflector body is provided with a through-hole extending in an axial direction of the deflector body, and a plurality of deflector channels are provided around the through-hole.

In some implementations, a plurality of deflector channels are evenly provided around the through-hole.

In some implementations, a plurality of mounting holes are provided spaced apart on the deflector body in a peripheral direction, and the plurality of mounting holes are extended in a radial direction of the deflector body respectively.

As another aspect of the present disclosure, provided is a turbine guide shoe, including the deflector device mentioned above.

In summary, the deflector device and the turbine guide shoe provided in the present disclosure provide technical effects as follows.

By providing a deflector channel extending in a spiral shape on the deflector body, fluid may flow out of the outlet side in a spiral-shaped fluid column. Also, a diameter of the deflector channel is configured to be gradually decreased in a direction from the inlet side to the outlet side. As the fluid flows from a position with a large diameter to a position with a small diameter, the pressure and flow rate of the fluid are increased, and with the helical flow, a high-speed helical fluid column is formed. When the fluid column impacts on the rotating structure, it further enhances the impact force on the rotating structure. For example, when it impacts on the turbine, it enhances the driving force for the rotation of the turbine, achieving high efficiency of fluid transportation and fully utilizing the kinetic energy of the fluid.

### BRIEF DESCRIPTION OF THE DRAWINGS

FIG. 1 is a structural diagram in a view of the deflector device of an embodiment of the present disclosure;

FIG. 2 is another view of the deflector device of FIG. 1; and

FIG. 3 is a diagram of an extension manner of the deflector channel of FIG. 1.

Labels:
1 deflector device; 10 deflector body; 11 inlet side; 12 outlet side; 13 deflector channel; 14 through-hole; 15 mounting hole.

### DETAILED DESCRIPTION OF THE EMBODIMENTS

For a better understanding and implementation, the technical solutions in the embodiments of the present disclosure are clearly and completely described below in conjunction with the attached drawings of the present disclosure.

In the description of the present disclosure, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

The present disclosure is further described below in conjunction with the attached drawings.

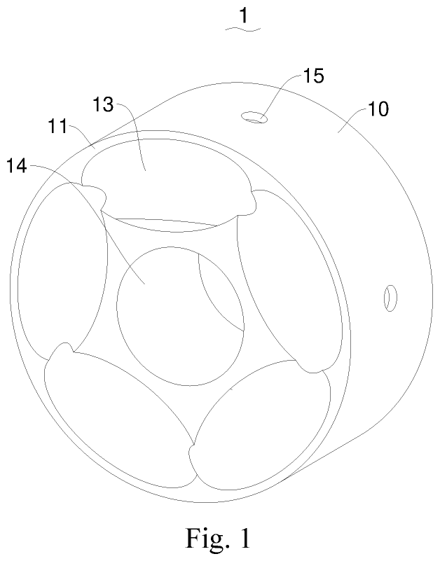

Referring to FIG. 1 to FIG. 3, provided is a deflector device 1 in the embodiment of the present disclosure, including a deflector body 10.

The deflector body 10 is provided with an inlet side 11 and an outlet side 12 opposite to each other, the deflector body 10 is provided with a plurality of deflector channels 13, the deflector channel 13 is extended in a spiral manner in a direction from the inlet side 11 to the outlet side 12, and a diameter of the deflector channel 13 is gradually decreased in a direction from the inlet side 11 to the outlet side 12.

By providing a deflector channel 13 extending in a spiral shape on the deflector body 10 in the deflector device 1 mentioned above, fluid may flow out of the outlet side 12 in a spiral-shaped fluid column. Also, a diameter of the deflector channel 13 is configured to be gradually decreased in a direction from the inlet side 11 to the outlet side 12. As the fluid flows from a position with a large diameter to a position with a small diameter, the pressure and flow rate of the fluid are increased, and with the helical flow, a high-speed helical fluid column is formed. When the fluid column impacts on the rotating structure, it further enhances the impact force on the rotating structure. For example, when it impacts on the turbine, it enhances the driving force for the rotation of the turbine, achieving high efficiency of fluid transportation and fully utilizing the kinetic energy of the fluid.

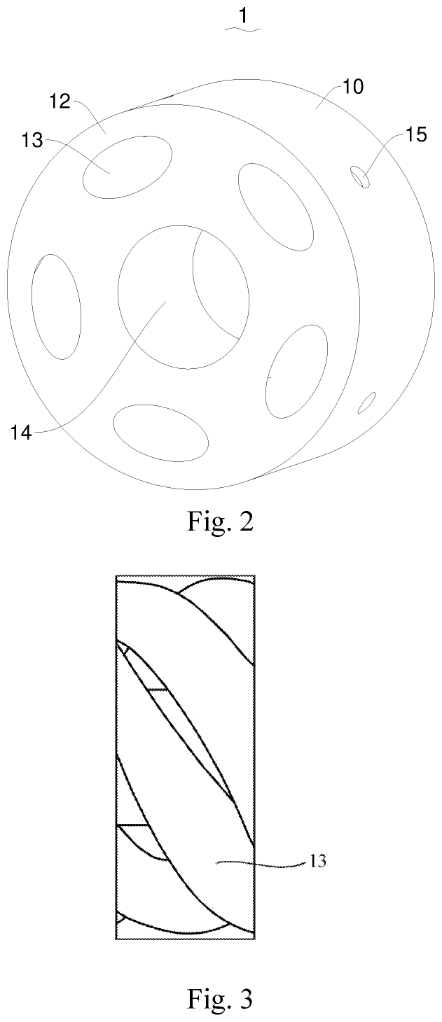

Specifically, referring to FIG. 1 and FIG. 2, when providing the deflector channel 13 in the deflector body 10, a cross-section of the deflector channel 13 is elliptical. The elliptical cross-section, as compared to the circular cross-section, allows the deflector channel 13 to have a larger cross-sectional area, i.e., a larger area of fluid overflow, which achieves an increase in fluid flow, resulting in a greater impact force and pressure. In other embodiments, the cross-section of the deflector channel 13 may also be adjusted to be circular or other shapes depending on the required fluid pressure.

Further, for fully utilizing the space of the deflector body 10, any two adjacent deflector channels 13 partially overlap one another at the inlet side 11. In such a setup, the deflector channel 13 is configured to have a partial overlap to allow full utilization of the space at the inlet side 11 of the deflector body 10 to enhance the space utilization rate of the deflector body 10.

FIG. 3 is a diagram of an extension manner of the deflector channel 13 in the deflector body 10 of the present embodiment.

In an implementation of the deflector device 1 of the present disclosure, the deflector device 1 is applied to a turbine guide shoe, which is used to create a greater impact from the fluid after it flows over the deflector device 1 so as to allow for a more efficient rotation of the turbine.

Specifically, the deflector device 1 and a turbine are provided sequentially in an axial direction of a housing of the turbine guide shoe. In the present embodiment, the deflector body 10 is provided with a through-hole 14 extending in an axial direction of the deflector body 10, and a plurality of deflector channels 13 are provided around the through-hole 14. The through-hole 14 is used for threading the rotating shaft of the turbine so that the turbine drives the rotating shaft as the turbine is rotated by the impact force of the fluid.

Further, when both the through-hole 14 and the plurality of deflector channels 13 are provided in the deflector body 10 in the axial direction, the plurality of deflectors are evenly provided around the through-hole 14 so that the fluid in each deflector channel 13 may deliver the same impact force to the turbine after the fluid flows out of the outlet side 12 to ensure the stability of the rotation of the turbine.

For facilitating the installation of the deflector device 1, a plurality of mounting holes 15 are provided spaced apart on the deflector body 10 in a peripheral direction, and the plurality of mounting holes 15 are extended in a radial direction of the deflector body 10 respectively. Specifically, the deflector device 1 is fixed by mounting to an internal wall of the housing of the turbine guide shoe by means of the mounting holes 15.

Further, in the present embodiment, the deflector body 10 may be prepared from a rigid material, for example from a metal.

By adopting the deflector device 1, when the dispersed fluid flows to the elliptical inlet side 11, it flows into the deflector channel 13, and the deflector channel 13 focuses on guiding the dispersed fluid, which gradually accelerates through the deflector channel 13 with a decreasing diameter and in a spiral shape to form a high-speed spiral fluid column. When flowing out of the outlet side 12, it is discharged at a high speed and high efficiency, thereby forming a strong impact force to achieve an increase in the impact force of the fluid and an increase in the efficiency of the fluid transfer, which fully utilizes the energy that the fluid flow generates.

In another embodiment of the present disclosure, the turbine guide shoe includes a housing, a turbine, a guide head, a turbine shaft, and a deflector device 1 mentioned above.

Specifically, the deflector device 1 is fixedly mounted on an internal wall of the housing. The deflector device 1 and the turbine are provided sequentially in a flowing direction of the fluid. The turbine shaft is sequentially threaded through the through-hole 14 of the deflector device 1 and the turbine. The turbine shaft is rotatably provided with respect to the housing. The guide head is provided at an end of the housing in a flowing direction of the fluid and is connected to the turbine. When fluid flows into the housing, for example, when drilling fluid flows into the housing, the drilling fluid is fed through the inlet side 11 of the deflector device 1, and the dispersed drilling fluid is concentrated and conveyed by the deflector channel 13. As the fluid flows in the deflector channel 13, which is spiral in shape and of decreasing diameter, and flows out of the outlet side 12, a high-speed spiral fluid column is formed, the impact force is increased and impacts on the turbine, the turbine rotates, the turbine rotation leads to the rotation of the guide head, and the drilling operation is achieved due to the setting of a gear part on the guide head.

It should be noted that, the deflector device 1 of the present embodiment may not only be applied to a turbine guide shoe, but also be used in a fluid-driven product to serve as an important component for guiding and enhancing the impact force of the fluid to drive a variety of mechanical devices, such as a turbine in a hydroelectric power plant, a compressor in an aero-engine, and may be applied to a hydraulic transmission system as a high-efficiency hydraulic pump, which may improve the efficiency of the hydraulic transmission.

The technical means disclosed in the solution of the present disclosure are not limited to those disclosed in the embodiments mentioned above but also include technical solutions consisting of any combination of the above technical features. It should be noted that for those skilled in the art, a plurality of improvements and modifications may be made without departing from the principles of the present disclosure. These improvements and modifications are also considered to be within the scope of protection of the present disclosure.

1. A deflector device, comprising a deflector body, wherein the deflector body is provided with an inlet side and an outlet side opposite to each other, the deflector body is provided with a plurality of deflector channels, each of the plurality of deflector channels is extended in a spiral manner in a direction from the inlet side to the outlet side, and a diameter of each of the plurality of deflector channels is gradually decreased in a direction from the inlet side to the outlet side.

2. The deflector device according to claim 1, wherein a cross-section of each of the plurality of deflector channels is elliptical in shape.

3. The deflector device according to claim 1, wherein any two adjacent deflector channels partially overlap one another at the inlet side.

4. The deflector device according to claim 2, wherein any two adjacent deflector channels partially overlap one another at the inlet side.

5. The deflector device according to claim 1, wherein the deflector body is provided with a through-hole extending in an axial direction of the deflector body, and the plurality of deflector channels are provided around the through-hole.

6. The deflector device according to claim 2, wherein the deflector body is provided with a through-hole extending in an axial direction of the deflector body, and the plurality of deflector channels are provided around the through-hole.

7. The deflector device according to claim 5, wherein the plurality of deflector channels are evenly provided around the through-hole.

8. The deflector device according to claim 6, wherein the plurality of deflector channels are evenly provided around the through-hole.

9. The deflector device according to claim 1, wherein a plurality of mounting holes are provided spaced apart on the deflector body in a peripheral direction, and each of the plurality of mounting holes is extended in a radial direction of the deflector body.

10. The deflector device according to claim 2, wherein a plurality of mounting holes are provided spaced apart on the deflector body in a peripheral direction, and each of the plurality of mounting holes is extended in a radial direction of the deflector body.

11. A turbine guide shoe, comprising a deflector device, wherein the deflector device comprises a deflector body, wherein the deflector body is provided with an inlet side and an outlet side opposite to each other, the deflector body is provided with a plurality of deflector channels, each of the plurality of deflector channels is extended in a spiral manner in a direction from the inlet side to the outlet side, and a diameter of the deflector channel is gradually decreased in a direction from the inlet side to the outlet side.

12. The turbine guide shoe according to claim 11, wherein a cross-section of each of the plurality of deflector channels is elliptical in shape.

13. The turbine guide shoe according to claim 11, wherein any two adjacent deflector channels partially overlap one another at the inlet side.

14. The turbine guide shoe according to claim 12, wherein any two adjacent deflector channels partially overlap one another at the inlet side.

15. The turbine guide shoe according to claim 11, wherein the deflector body is provided with a through-hole extending in an axial direction of the deflector body, and the plurality of deflector channels are provided around the through-hole.

16. The turbine guide shoe according to claim 12, wherein the deflector body is provided with a through-hole extending in an axial direction of the deflector body, and the plurality of deflector channels are provided around the through-hole.

17. The turbine guide shoe according to claim 15, wherein the plurality of deflector channels are evenly provided around the through-hole.

18. The turbine guide shoe according to claim 16, wherein the plurality of deflector channels are evenly provided around the through-hole.

19. The turbine guide shoe according to claim 11, wherein a plurality of mounting holes are provided spaced apart on the deflector body in a peripheral direction, and each of the plurality of mounting holes is extended in a radial direction of the deflector body.

20. The turbine guide shoe according to claim 12, wherein a plurality of mounting holes are provided spaced apart on the deflector body in a peripheral direction, and each of the plurality of mounting holes is extended in a radial direction of the deflector body.
